(19) United States
(12) Patent Application Publication
(10) Pub. No.: US 2010/0222086 A1
(43) Pub. Date: Sep. 2, 2010

(54) Cellular Phone and other Devices/Hands Free Text Messaging

(76) Inventor: Karl Schmidt, El Dorado Hills, CA (US)

Correspondence Address: WILSON DANIEL SWAYZE, JR., 3804 CLEARWATER CT., PLANO, TX, 75025, US

(21) Appl. No.: 12/395,632

(22) Filed: Feb. 28, 2009

(51) Int. Cl. H04W 4/00

(52) U.S. Cl. 455/466

(57) ABSTRACT

A user terminal for text messaging may include a circuit for entering a text message corresponding to the voice of the user to be sent to a recipient; a circuit for storing the text message to be sent to the recipient; and a circuit for sending the text message in response to the voice of the user. The user terminal may be a cell phone, and the user terminal may be a PDA. The text message may be stored in response to the voice of the user, and the recipient of the text message may be determined in response to the voice of the user. The user terminal may be adapted for Web browsing in response to the voice of the user, and the user terminal may be adapted for formatting in response to the voice of the user.

### FIELD OF THE INVENTION

This invention relates generally to generating and sending text messages, and more particularly, to hands free text messaging with a cell phone or other such devices.

### BACKGROUND OF THE INVENTION

In recent years, wireless electronic devices, such as cellular telephones, have been becoming more and more popular as communication instruments due to their decreasing sizes and increasing mobility.

The use of cellular phones and text messaging has increased over the years. Typically, the user must key in a phone number in order to place a call to another user. Additionally if the user wishes to text message then, the user must key in the text message by using various buttons on the cell phone. This requires manual dexterity and concentration in order to achieve a successful text message. Some individuals may lack the manual dexterity required to accurately text message. Furthermore, some activities such as driving a car or truck require the user's attention for that activity and may not be able to provide sufficient attention to text messaging. In these instances, the conventional method of text messaging may not be satisfactory for the user.

U.S. Pat. No. 5,697,060 discloses a portable wireless voice message transmitter over packet switched network for transmitting a voice message. The transmitter is capable of transmitting a voice message and text-based information when a user makes an emergency call to a special address with which the text-based information is associated. The transmitter includes text-based information setting circuit for setting text-based information, a first memory for storing the text-based information, a special address setting circuit for setting a special address which is associated with the text-based information and a second memory for storing the special address. The transmitter also includes a microphone for inputting a voice message, a third memory for storing the voice message, a destination setting circuit for setting a destination, a transmission start key operable by a user for generating a transmission start signal and a transmitter circuit responsive to the transmission start signal for transmitting the voice message stored to the destination address. When the destination address is coincident with the special address stored in the first memory, the transmitter circuit transmits the text-based information as well as the voice message to the destination address so that the message recipient receives both the voice message and the text-based information.

U.S. Pat. No. 6,205,342 describes methods and apparatuses for composing text messages using wireless electronic devices, such as cellular telephones. Specifically, a word list including a set of pre-selected words and a set of dynamically updated words is stored in a cellular telephone. The words in the word list are then displayed on the cellular telephone in a circular fashion. A user can select the words displayed on the cellular telephone to compose a text message. To reflect word usage pattern of the user, the second set of words is updated based on text messages previously composed.

### SUMMARY

A user terminal for text messaging may include a circuit for entering a text message corresponding to the voice of the user to be sent to a recipient; a circuit for storing the text message to be sent to the recipient; and a circuit for sending the text message in response to the voice of the user.

The user terminal may be a cell phone, and the user terminal may be a PDA.

The text message may be stored in response to the voice of the user, and the recipient of the text message may be determined in response to the voice of the user.

The user terminal may be adapted for Web browsing in response to the voice of the user, and the user terminal may be adapted for formatting in response to the voice of the user.

The text message may be directed to an e-mail address, and the terminal may be a Blackberry.

The terminal may be a laptop computer; the terminal may be an iPod, and the terminal may be a Dick Tracy type wrist mounted phone.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a portion of the electrical components of the present invention;

FIG. 2 illustrates additional electrical components of the present invention;

FIG. 3 illustrates a flow chart of the present invention; and

FIG. 4 illustrates a portion of the user terminal.

### DETAILED DESCRIPTION

The present invention may use voice to text technology or software to convert the user's voice into a text message. The text message may be formed on a cellular phone and after the text message may be complete, the text message is sent to a recipient by employing a destination address of the recipient. The present invention may use a touchscreen, a menu or other appropriate input device in order to activate the voice to text technology. The user may identify the recipient of the text message and then generate text to be sent to the recipient or may generate the text to be sent to the recipient and then identifies the recipient to send the text to. The identity of the recipient may be obtained by voice to text technology. The user may simply speak the name of the recipient to identify the recipient and the destination address of the recipient. The destination address may be used by the cell phone carrier to place the text message with the recipient. Alternatively, the recipient could be identified from another source from the cell phone such as the contacts menu. The recipient may be an individual recipient or could be a group of recipients to receive the same text message. The present invention will describe a recipient that could mean a single recipient or multiple recipients. The user may generate the text message to be sent to the recipient by speaking the desired text message, and the user's voice is used by the voice to text technology in order to generate the text message on the cell phone. The text message may be viewed on the screen/touchscreen of the cell phone and the user may change or add to the text message as desired by the user. The voice to text technology may employ smart buttons which may be displayed on the screen or touchscreen to allow the user to scroll through menu options and to quickly make a desired selection. The voice to text technology may include voice commands that are activated by speaking ‘keywords’ that controls text, stop, play, review and send, and corrects and edits by voice. The voice to text technology may include formatting by voice and web browsing by voice, for example using Internet Explorer. The voice to text technology may include ‘mousing’ by voice and locating commands with a Command Browser by voice. The teachings of the present invention are equally applicable to laptop computers, personal computers, i phones, palms, smartphones cellular phones, BlackBerrys, PDAs, iPods Dick Tracy type wrist mounted phones, and other wireless devices. These devices may be referred to as user terminals. The generated voice to text message may be sent to an e-mail address or a phone number which could be designated by the user or could be a e-mail address that has been previously stored on the terminal device.

FIG. 2 shows a block diagram 200 to illustrate some components of the user terminal 101 in accordance with the present invention.

The block diagram 200 may include a processor 204, an I/O (input and output) interface circuit 205, a graphic I/O interface circuit 206, a memory 208, and a bus 210. The processor 204, the I/O interface circuit 205, the graphic I/O interface circuit 206, and the memory 208 may be all coupled to the bus 210.

The memory 208 may include: (1) a text message memory 213 for storing the text message composed by a user, and (2) an application memory 220 for storing an application to compose text messages in accordance with the present invention. The application memory 220 may include the voice to text technology as described here within.

The processor 204 may control the operations of the I/O interface circuit 205, the graphic I/O interface circuit 206, the memory 208, and the display region 102. More specifically, the processor 204 may be able to: (1) get access to the text message memory 213, (2) interact with the control panel 106 via the interface circuit 205, (3) display the words contained in the text message memory 213 on the display region 102 via the graphic I/O interface circuit 206, (4) execute the application stored in the application memory 220 to compose a text message by comparing the inputted voice and comparing it to potential text words to be used in the text message and choosing the best possible match and placing the text word into the text message, and (5) store the composed text message in the text message memory 213.

In response to a user's voice in the microphone 108 or a user's press of any key 30 on the key panel 110 which may be dedicated to activation of the voice to text, the control panel 106 generates a request signal, which is in turn sent to the processor 204 via the I/O interface circuit 205. In response, the processor 204 executes the voice to text application stored in the application memory 220, thereby performing voice to text function for the request signal. New text words can be generated by the keyboard 30 or by voice.

The display 102 selectively displays a destination address and other text-based information as the user selects either by voice or manual devices. After a desired destination address is set, the user pushes send key to transmit the text message or generates a voice command to transmit the text message by the voice to text function.

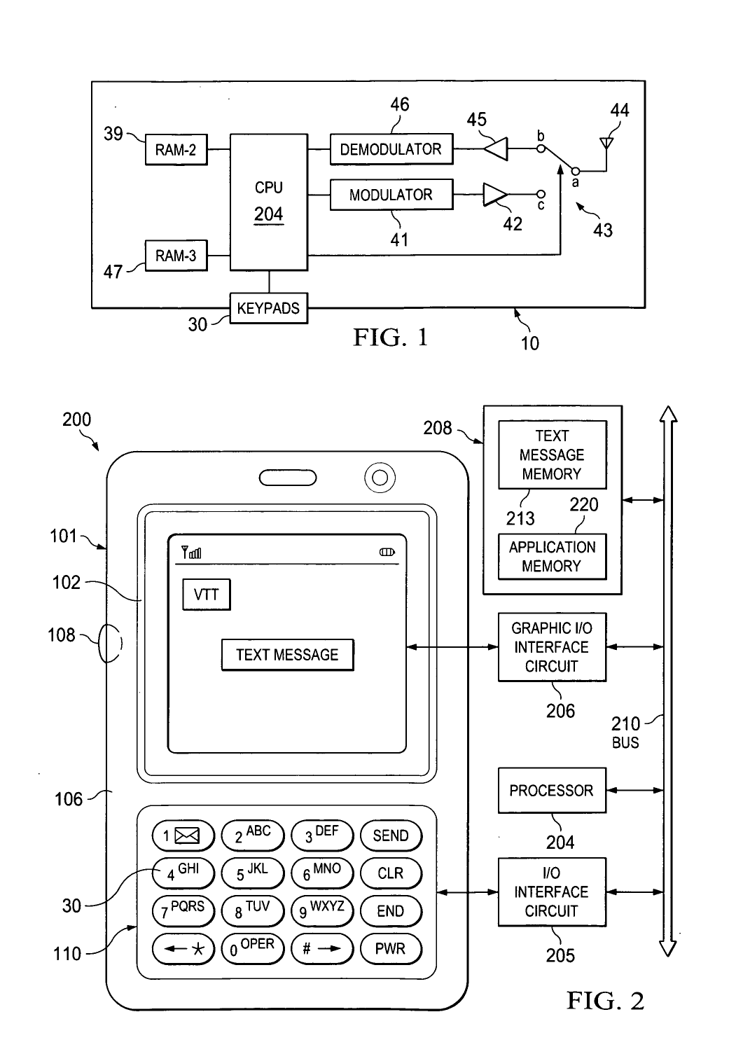

FIG. 1 is a block diagram showing an embodiment of internal circuits of transmitter/receiver terminal 101. FIG. 1 illustrates an antenna 44 for receiving and broadcasting text messages. A text message is received and the switch 43 is set to connect amplifier 45 to the antenna 44. The amplifier 45 amplifies the received signal and transmits it to the demodulator circuit 46 where the text message is demodulated. The CPU/processor 204 stores the text message in RAM-2 39 to be displayed to the user. Once a text message has been generated for transmission, the CPU/processor 204 transmits the text message from the RAM-3 47 to the modulator circuit 41 wherein the text message is modulated and transmitted to amplifier 42 where the text messages are amplified and connected to be transmitted to the antenna 44 by the switch 43.

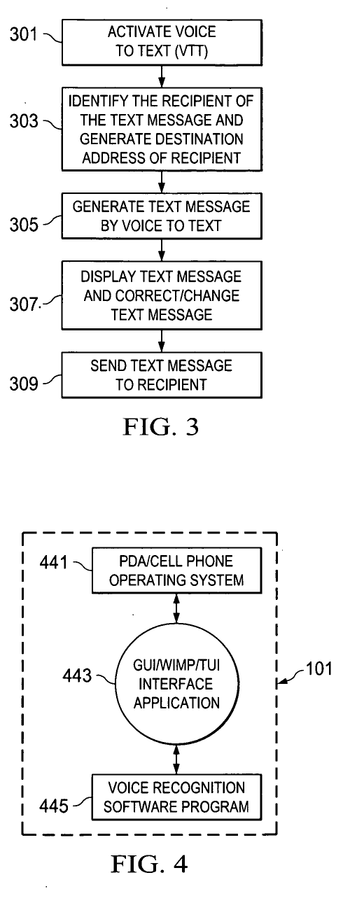

FIG. 3 illustrates a flow chart to explain the steps of using voice to text functions to activate a user terminal 101, to determine a recipient and to generate a destination address of the recipient, to generate a text message by using the voice and voice commands of the user, to correct and change the text message and to send a text message to recipient in response to a voice command

FIG. 3 illustrates in step 301, the step to activate the voice to text function, and in step 303, the user by the voice to text function identifies the recipient of the text message and generates a destination address of the recipient. In step 305, the user generates the text message by the voice to text function, and in step 307, the user displays the text messages and may correct or change the text message by using the voice to text function. In step 309, the user issues a voice command to the voice to text function to send a text message to the recipient at the destination address.

FIG. 4 illustrates an overview of the operation of the present invention. FIG. 4 illustrates that the GUI, wimp, or TUI interface application 443 to control the graphic I/O interface circuit 206 may interface with the terminal operating system 441 which may be located in the CPU/processor 204 and which may be a PDA/cell phone operating system or other type of operating system appropriate to the device being used.

A graphical user interface (GUI, wimp or TUI) may be a type of user interface which allows people to interact with electronic devices such as computers; hand-held devices such as MP3 Players, Portable Media Players or Gaming devices; household appliances and equipment but not limited to alarm systems, lighting systems, HVAC systems and other electric and electronic systems and equipment and office equipment. A GUI, WIMP (window, icon, menu, pointing device) or TUI (text-based user interface) may include graphical icons, and visual indicators, as opposed to text-based interfaces, typed command labels or text navigation to fully represent the information and actions available to a user. The actions are usually performed through direct manipulation of the graphical elements. The GUI, WIMP or TUI interface application 443 may interface with the voice recognition software program 445 which may be located in the application memory 220 to convert the voice of the user to text which may be used as a text message.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A user terminal for text messaging, comprising:
a circuit for entering a text message corresponding to the voice of the user to be sent to a recipient;
a circuit for storing the text message to be sent to the recipient;
a circuit for sending the text message in response to the voice of the user.

2) A user terminal for text messaging as in claim 1, whenin the user terminal is a cell phone.

3) A user terminal for text messaging as in claim 2, wherein the user terminal is a PDA.

4) A user terminal for text messaging as in claim 1, wherein the text message is stored in response to the voice of the user.

5) A user terminal for text messaging as in claim 1, wherein the recipient of the text message is determined in response to the voice of the user.

6) A user terminal for text messaging as in claim 1, wherein the user terminal is adapted for Web browsing in response to the voice of the user.

7) A user terminal for text messaging as in claim 1, wherein the user terminal is adapted for formatting in response to the voice of the user.

8) A user terminal for text messaging as in claim 6, wherein the text message is directed to an e-mail address.

9) A user terminal for text messaging as in claim 1, wherein the terminal is a Blackberry.

10) A user terminal for text messaging as in claim 1, wherein the terminal is a laptop computer.

11) A user terminal for text messaging as in claim 1, wherein the terminal is an iPod.

12) A user terminal for text messaging as in claim 1, wherein the terminal is a Dick Tracy type wrist mounted phone.
